(19) United States
(12) Patent Application Publication
(10) Pub. No.: US 2008/0106370 A1
(43) Pub. Date: May 8, 2008

(54) System and method for speech-recognition facilitated communication to monitor and control access to premises

(75) Inventors: Daniel Perez, Foothill Ranch, CA (US); Jonathan Becerra, Cypress, CA (US)

Correspondence Address: JAFARI LAW GROUP, P.C., 801 N. PARKCENTER DRIVE, SUITE 220, SANTA ANA, CA, 92705, US

(73) Assignee: Viking Access Systems, LLC

(21) Appl. No.: 11/592,520

(22) Filed: Nov. 2, 2006

(51) Int. Cl. G06F 7/04; G10L 17/00

(52) U.S. Cl. 340/5.7; 340/5.84; 704/273; 704/E17.003

(57) ABSTRACT

The invention is a system and method for accessing premises utilizing speech recognition technology. By presenting an audible set of options, recognizing words, phrases, or numbers, from a first speech source and then presenting an audible set of options until a final command has been recognized, a wired or wireless conversation may be established. The conversation may be between the first speech source and a second speech source originating within the premises or from a remote location, wherein the second speech source may send a command, generating an opening signal to a movable barrier operator via said communication, granting access to the premises.

### TECHNICAL FIELD OF THE INVENTION

This invention relates generally to a system and method for communicating using speech recognition technology to monitor and control access to a premise, and in particular, a device that utilizes speech recognition technology to facilitate remote monitoring and controlling of an access point to premises.

### BACKGROUND OF THE INVENTION

In the past, entry systems have comprised of individuals monitoring and controlling an access point to a secured premise, for example a gated community. These individuals would be responsible for following proper procedures for allowing visitors to enter the secured premise, for example requiring identification and subsequent permission from residents to grant access. Eventually, these systems were replaced, at least in part, by devices that allowed visitors to establish communication with parties inside the premises, for example tenants, so as to give such tenants the opportunity to monitor and control others desiring to enter their building. Generally, the established communication also serves as a means by which tenants can provide access on to the premise; sometimes by pressing a number on their telephone keypad that unlocks, opens or otherwise grants access inside.

Typically, these devices are located a considerable distance from a gate, doorway, or barrier, in the perimeter of a premise. Visitors have to either step out of their vehicles or even have to walk up to these devices to establish communication with a party inside the premise if they want to gain access on to the premise.

These current systems carry various problems particularly in areas where harsh weather is common during the several seasons. Rain, snow, very cold or very hot weather can be upsetting and uncomfortable to visitors, even if only to extend an arm out of a vehicle in reaching a keypad common in today's access systems.

Presently, the art has been unable to adequately solve this problem. There is a need in the art for a system and method that facilitates the required communication between parties at such access points to a premise. It is to these ends that the present invention has been developed.

### SUMMARY OF THE INVENTION

To minimize the limitations found in the prior art, and to minimize other limitations that will be apparent upon the reading of the specification, the present invention provides a system and method for facilitating communications to remotely monitor and control an access point to a premise, for example a gated community, using speech recognition technology.

A method in accordance with the present invention, comprises receiving a verbal communication from a first user, utilizing a speech recognition circuitry to derive an identification data from the verbal communication, matching the identification data with a second user, contacting the second user associated with the identification data, receiving a command from the second user to open a movable barrier, relaying the command from the second user to a movable barrier operator connected to the movable barrier, and granting the first user access to the premises.

A system in accordance with the present invention, comprises a circuitry for receiving a verbal communication from a first user, a speech recognition circuitry for recognizing the verbal communication from the first user, a controller for deriving an identification data from the verbal communication, wherein that identification data is associated with a second user, a communication circuitry for communicating with the second user, a network for establishing a communication between the first user and the second user, a receiving circuitry for relaying a command from the second user, and a relay for sending the command from the second user to a movable barrier operator.

It is an object of the present invention to utilize speech recognition technology to facilitate establishing a communication between a user situated outside a premises and a user capable of granting access to the premises.

It is another object of the present invention to use speech recognition technology to facilitate opening a movable barrier to provide access to premises.

These and other advantages and features of the present invention are described with specificity so as to make the present invention understandable to one of ordinary skill in the art.

### BRIEF DESCRIPTION OF THE DRAWINGS

Elements in the figures have not necessarily been drawn to scale in order to enhance their clarity and improve understanding of these various elements and embodiments of the invention. The drawings are generalized in form in the interest of clarity and conciseness.

FIG. 1 illustrates a basic layout of a system, in accordance with one embodiment of the present invention, for facilitating communication to remotely monitor and control access to premises, utilizing an access device with speech recognition capabilities.

FIG. 2 illustrates a block diagram of the various components of access device 100 in accordance to one embodiment of the present invention.

FIG. 3 illustrates a block diagram of internal components of an access device that utilizes hardware and software to receive, recognize, and process verbalized commands, in accordance to one embodiment of the present invention.

FIG. 4 illustrates a block diagram of the internal components of an access device that utilizes only software to receive, recognize, and process verbalized commands, in accordance to another embodiment of the present invention.

FIG. 5 illustrates a flow chart of a method for speech recognition facilitated communication to monitor and control access to premises, in accordance with an exemplary embodiment of the present invention.

### DETAILED DESCRIPTION OF THE DRAWINGS

In the following discussion that addresses a number of embodiments and applications of the present invention, reference is made to the accompanying drawings that form a part hereof, and in which is shown by way of illustration specific embodiments in which the invention may be practiced. It is to be understood that other embodiments may be utilized and changes may be made without departing from the scope of the invention.

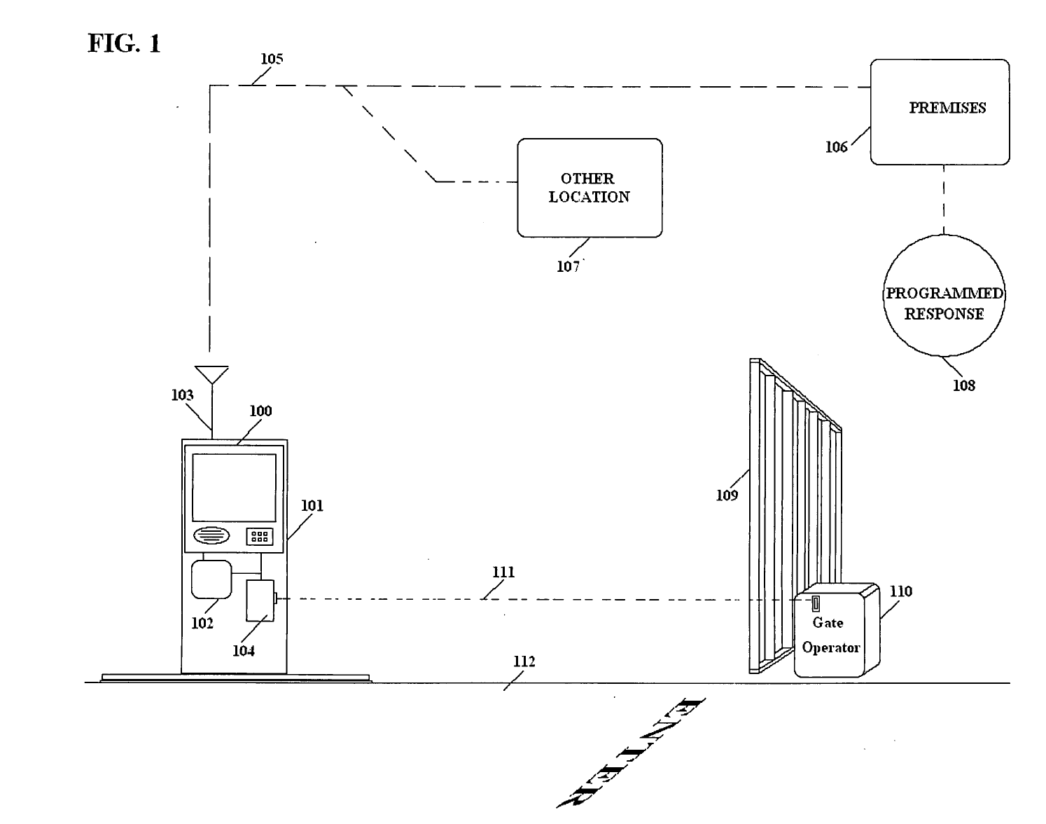

FIG. 1 illustrates a basic layout of a system, in accordance with one embodiment of the present invention, for facilitating communication to remotely monitor and control access to a premise, utilizing an access device with speech recognition capabilities.

FIG. 1 shows access device 100 installed in access device casing or housing 101. Access device 100 is connected to communications network interface 102 and relay 104. Here, communication network interface 102 is utilizing antenna 103 to establish communication (signal) 105 to either premise 106, other location 107, or to connect a user to programmed response 108.

Access device 100 is situated several yards from gate 109, on driveway 112. Gate 109 (shown in the open position) is operated by gate operator 110 (shown behind gate 109), located inside the premise for which gate 109 is an access point.

Although access device 100 is situated on driveway 112, access device 100 may be installed in a lobby to a building, on the entrance to a parking lot, near the doorway to a house, or any other access point to any type of premise, without departing from the scope of the present invention.

Housing 101 may be constructed of any type of material suitable for containing the electrical components of access device 100. Typically, housing 101 provides protection from the elements, for example and without limiting the scope of the present invention, housing 101 is waterproof. Of course, this type of protection might not be necessary in settings where access device 100 is not exposed to rain or snow. In an exemplary embodiment, housing 101 is constructed to protect access device 100 from the natural elements, against theft, from regular wear and tear, and may be removed for servicing of access device 100.

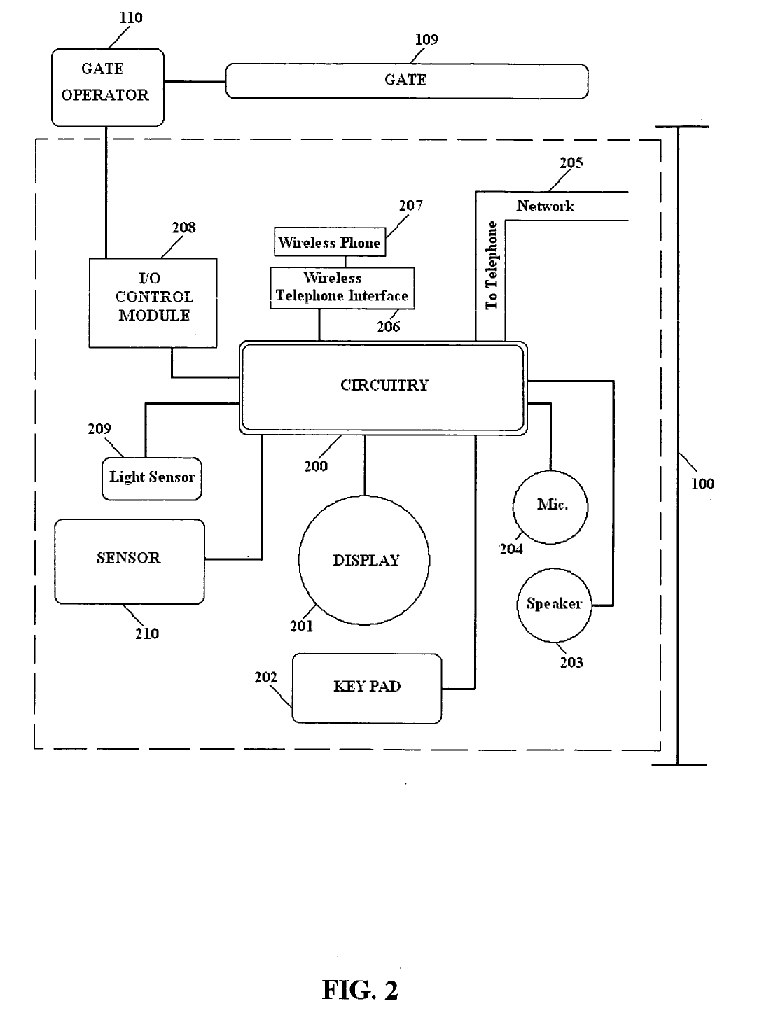

Communication network interface 102 may be any type of communication device capable of establishing communication signal 105. In one embodiment, communication interface 102 is a telephone and establishes communication through a telephone network. In another embodiment, communication interface 102 is a modem connected to the internet through a LAN connection and establishes communication using internet phone software. Here, communication network interface 102 is shown as an external device connected to access device 100 however, in another embodiment, access device 100 may contain an internal communication network interface such as communication network interface 102, in such embodiment, external communication network interface 102 would not be necessary since being replaced by the internal component (see FIG. 2).

In an exemplary embodiment, communication interface 102 is a wireless phone interface connecting access device 100 to a wireless phone which has been integrated within access device 100. Antenna 103 allows communication interface 102 to establish better signals and higher quality communications.

Relay 104 is connected to an internal circuitry (discuss in greater detail below) in access device 100 to relay a signal generated from a command from a party located, for example, in premise 106 wishing to grant access to a user through gate 109. Relay 104 is used to send signal 111 to gate operator 110. This signal may be an infra red signal, a radio frequency signal, or a signal through a land line to open gate operator 110. Here, relay 104 is shown as an external device connected to access device 100 however, in another embodiment, access device 100 may contain relay 104 internally.

FIG. 1 shows antenna 103 through which signal 105 travels establishing communication with premise 106, other location 107, or a programmed response 108. As shown in FIG. 1, signal 105 is a mobile phone signal; however, it may be achieved using a regular telephone signal through a land line, an internet connection using an internet phone, or any other method known in the art of communicating a user with another party, without departing from the scope of the present invention.

Typically premise 106 is a location inside the premise guarded by gate 109. In one embodiment, premise 106 comprises an apartment located in an apartment complex accessible through gate 109. In another embodiment premise 106 comprises a reference desk in a lobby of a building accessible through gate 109. In yet another embodiment, premise 106 comprises a secretary's office located in a commercial building accessible through gate 109.

Other location 107 may be an alternative location, where a party that is not presently in the premise may be reached to gain access through gate 109. In one embodiment, other location 107 may be a mobile phone, a workplace, or any other location where a party being sought by a user may be reached via signal 105.

In an exemplary embodiment, access device 100 contains a database of various phone numbers associated with each party, for example tenants, within the premise accessible through gate 109. Each tenant in the premise may provide their apartment's phone number, their mobile phone number, and a workplace number where that tenant may be reached. Access device 100 may prompt a user, for example a visitor, to choose from the provided list of numbers to establish a communication with the party capable of granting access through gate 109. Once access device 100 establishes a communication between a user and a party, for example a tenant with access to gate 109, the party may use any method known in the art to provide the user with access (i.e. open gate 109).

In one embodiment, dual tone multi-frequency (DTMF) signaling is used. This is a common method used to send a signal over the phone, for example pressing a number on a telephone keypad to send a command via communication signal 105 from premise 106 or other location 107 to access device 100, which in turn, relays that command signal to relay 104, sending signal 111 to gate operator 110 to open gate 109.

In this way, a user may be granted access through gate 109 from premise 106, for example an apartment, or from other location 107, for example a workplace where the contacted party is presently situated. This is desirable in particular if a party interested in having a service performed within a premise is not present within the premise but wishes to grant access to a user such as a cable installer, a delivery person, or any other individual that may need access through gate 109.

Programmed response 108 may be implemented with access device 100 as an alternative to parties interested in granting users access to a premise without being directly contacted. In one embodiment, programmed response 108 may be a message indicating to users that the party they seek is unavailable.

In another embodiment, programmed response 108 may be a prerecorded message requesting a user to input (verbally or physically) a key or password in order to be granted access through gate 109.

For example, and without limiting the scope of the present invention, a user drives up to access device 100 and initiates a request to communicate with a tenant in a building located through gate 109 by verbally providing access device 100 with the-name of the tenant. Access device 100 uses its speech recognition equipment (discussed in more detail below) to process the user's speech (e.g. name of tenant provided by user) to match the provided name with access device 100's database of tenants. Once a match is found and confirmed, access device 100 utilizes communication network interface 102 to send a communication signal 105 through antenna 103 to premise 106 or to other location 107. If a tenant is in fact reached at either location, the tenant may provide a DTMF, for example pressing the number 9 on their telephone key, to command access device 100 to open gate 109. Access device 100, receiving the correct DTMF, uses relay 104 to send signal 111 to gate operator 110 to open gate 109. However, if access device 100 cannot establish a communication with the tenant, programmed response 108 may be accessed by access device 100 when there is no response from the tenant at either premise 106 or other location 107 in a fashion similar to an answering system.

Access device 100 may connect a user with programmed response 108. Programmed response 108 may be a prerecorded message requesting the user to enter a password (i.e. a password previously provided to the user by a tenant in access device 100's database). Upon hearing the message, or programmed response 108, a user may state the speech that matches the password access device 100 has stored in its database associated with said user. Access device 100's speech recognition circuitry (discuss in greater detail below) recognizes the spoken password (which may be a word, a series of numbers or any other type of password) and searches for a match in its database. If the spoken password is matched with the password associated with the party sought by the user, access device 100 sends a signal to relay 104 and sends signal 111 to gate operator 110, opening gate 109.

Gate 109 is shown as the entry gate to a premises, however, gate 109 may be any type of movable barrier known in the art. Gate 109 could be a door for a small entity, or a gate for a large entity (i.e. a vehicle), which can swing out, slide open, or even roll upwards.

Gate operator 110 is shown as a movable barrier operator that slides gate 109 to open gate 109 and allow access to premises via driveway 112. However, gate operator 110 may be any system that controls a barrier to an entry, an exit, or a view. Furthermore, gate operator 110 may be an unlocking mechanism that simply unlocks or opens a movable barrier to allow access to premises.

Now turning to FIG. 2, the internal components of access device 100, in accordance to one embodiment of the present invention, are discussed in reference to the illustrated block diagram.

Access device 100 comprises of circuitry 200, display 201, key pad 202, speaker 203, microphone 204, telephone network interface 205, wireless telephone interface 206, wireless phone 207, input/output control module 208, light sensor 209, and presence sensor 210.

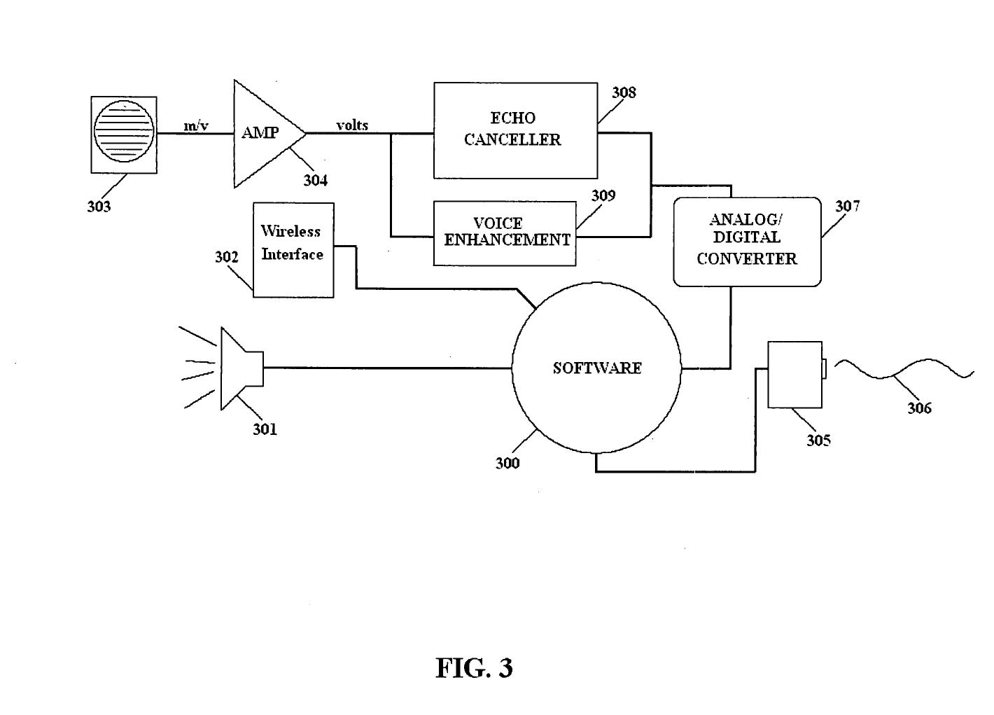

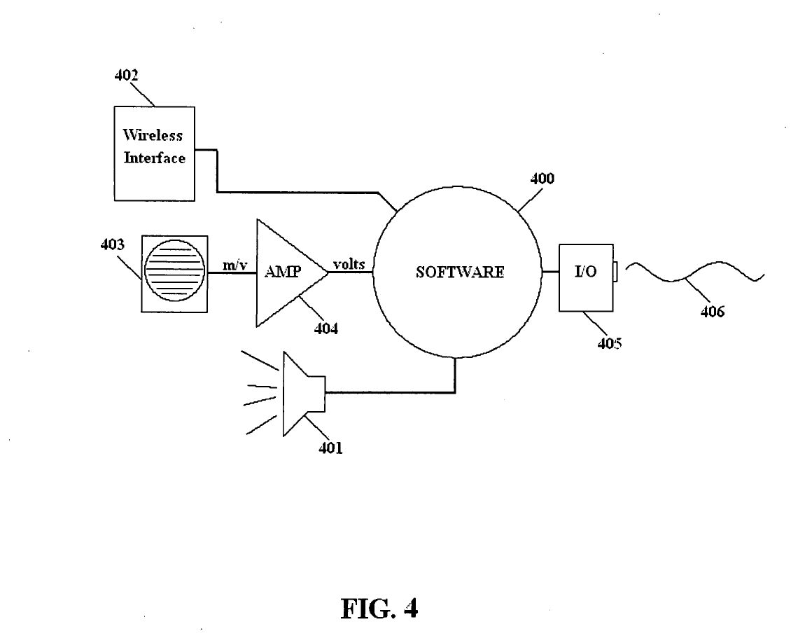

Circuitry 200 is capable of recognizing speech. In one embodiment circuitry 200 includes hardware for speech recognition. In another embodiment, circuitry 200 comprises of software that can perform speech recognition tasks and eliminates the need for speech recognition hardware such as echo cancellers and voice enhancers (see FIGS. 3 and 4). Additionally, circuitry 200 may comprise of software that can detect DTMF signals for relaying a command to a device, for example a gate operator.

In an exemplary embodiment, circuitry 200 comprises both software and hardware for speech recognition tasks such as speaker-dependent and speaker-independent speech recognition capabilities. These tasks may comprise of voice dialing, call routing, or simple data entry, such as verbally providing access device 100 with a password.

Typically circuitry 200 uses at least one of the well known methods in the art used for speech recognition systems. The various technologies used include Hidden Markov models, neural networks, automatic speech recognition, pattern matching algorithms, frequency estimation, matrix representation, and decision trees. Some systems also use “anti-speaker” techniques, such as cohort models, and world models. Although known in the art, these systems will be briefly discussed in turn for reference purposes and shall not be construed as limiting the scope of the present invention.

In one embodiment of the present invention circuitry 200 utilizes a Hidden Markov Model (HMMs)-based speech recognition system. Modern general-purpose speech recognition systems are typically based on HMMs. This is a statistical model which outputs a sequence of symbols or quantities. HMMs are popular because they can be trained automatically and are simple and computationally feasible to use.

In another embodiment, circuitry 200 utilizes neural networks (NN)-based speech recognition. There are also NN-HMM hybrid systems that use the neural network part for phoneme recognition and the Hidden Markov model part for language modeling.

Additionally, a well known method has been automatic speech recognition, to cope with different speaking speeds. In general, it is a method that allows a computer to find an optimal match between two given sequences with certain restrictions, that is, the sequences are “warped” non-linearly to match each other. This sequence alignment method is often used in the context of hidden Markov models.

In an exemplary embodiment, circuitry 200 utilizes speech recognition technologies that make access device 100 adaptable for speaker dependent or speaker independent systems. Furthermore, circuitry 200 uses known technologies that provide noise reduction for clarity and easy vocalized data processing, voice filtering for reduction of unwanted ambient noise, voice enhancement capabilities, and audio output capabilities for welcoming and instructing users. Additional discussion of several embodiments for circuitry 200 is included in reference to FIG. 3 and FIG. 4 below.

Display 201 may be a computer screen such as a computer monitor, or an LCD screen, or any other type of display without departing from the scope of the present invention. In addition, display 201 may display graphics to provide an aesthetically pleasing interface for users, and may be used as a means to display information such as instructions for individuals that may be hearing impaired.

Display 201 may provide different visual options for users including a choice of several means of locating the party a user is seeking via access device 100. For example, access device 100 displays on display 201 a list of three different phone numbers to locate a party who is not present in the premise and informs a user (verbally or via text instructions) of the several options to contact the party if the user wishes to gain access to the premise.

Key pad 202 may be a numerical input device, an alphanumerical input device, a computer's key board, a simple multi-key input device, or any other type of input device for users unable to provide vocalizations, for example handicapped individuals, to utilize access device 100.

Furthermore, key pad 202 may be replaced by display 201. In one embodiment, display 201 comprises touch-screen technology thus making key pad 202 unnecessary. In another embodiment, key pad 202 comprises of a touch-pad. In an exemplary embodiment, however, key pad 202 is only use as an alternative and primary interaction between users and access device 100 is vocalized using speaker 203 and microphone 204.

Speaker 203 and microphone 204 may be any type of suitable speaker and microphone system for access device 100 to provide (respectively) users with verbal instructions and receive verbal commands from users to be processed by circuitry 200. Any type of microphone and speaker system known in the art as suitable for speech recognition purposes may be used without departing from the scope of the present invention.

Telephone network interface 205 may be connected to access device 100 to communicate with a telephone network already existing in a premise, for example a land line in a gated community or a land line in an apartment building. In one embodiment, telephone network interface 205 is the only means to communicate users to interested parties, however, in another embodiment telephone network interface 205 is an alternative means of communication for access device 100.

As shown in FIG. 2, access device 200 also comprises of a wireless telephone interface 206 and a wireless telephone 207. This may be desirable to avoid trenching involved when installing such devices in the field. Using a wireless telephone adds simplicity to installation and reduces the heavy costs of connecting access device 100 to a land line on a premise. In an exemplary embodiment, access device 100 only comprises of a wireless communication system and utilizes only wireless telephone interface 206 and wireless telephone 207.

For example, wireless telephone interface 206 may be a USB port connected to circuitry 200 where wireless telephone 207 may be in turn connected, however, wireless telephone 207 may be connected to circuitry 200 using any known method in the art without departing from the scope of the present invention.

Input/output control module (I/O) 208 may be internal or external to circuitry 200. I/O 208 comprises a basic interface with at least one relay (not shown, for example relay 104 (see FIG.1), and a basic interface with at least one transistor (not shown). Additionally, I/O 208 provides an interface to connect light sensor 209, gate operator 110 or any device to signal gate operator 110, for example relay 104. I/O 208 may also connect circuitry 200 with sensor 210, key pad 202, display 201, microphone 204, and speaker 203.

Light sensor 209 may be used at night time or at times when not enough light is available for access device 100. Light sensor 209 may be used for actuating or changing luminosity in display 201, actuating lights to illuminate access device 100, or actuating lights to illuminate key pad 202.

Sensor 210 may be a presence sensor used to detect the presence of a user, for example someone in a car driving up on driveway 112 to utilize access device 100. Sensor 210 may be an inductive sensor, a capacitance sensor, a magnetic sensor, an ultrasonic sensor, a retro reflective sensor, an optical sensor, or any other type of sensor known in the art, without departing from the scope of the present invention.

In an exemplary embodiment, sensor 210 comprises inductive sensors utilized to detect vehicles approaching access device 100 via driveway 112. As known in the art, an inductive sensor is an electronic proximity sensor, which detects metallic objects without touching them. Sensor 210 may consists of an induction loop buried several centimeters underneath driveway 112. An electric current may be generated to form a magnetic field, which collapses generating a current that falls asymptotically toward zero from its initial level when the input electricity ceases. The inductance of the loop changes according to the material inside it and since metals are much more effective inductors than other materials the presence of metal increases the current flowing through the loop. This change can be detected by sensing circuitry such as circuitry 200, which can signal to some other device, for example lights illuminating access device 100, whenever some metal source such as a vehicle, is detected.

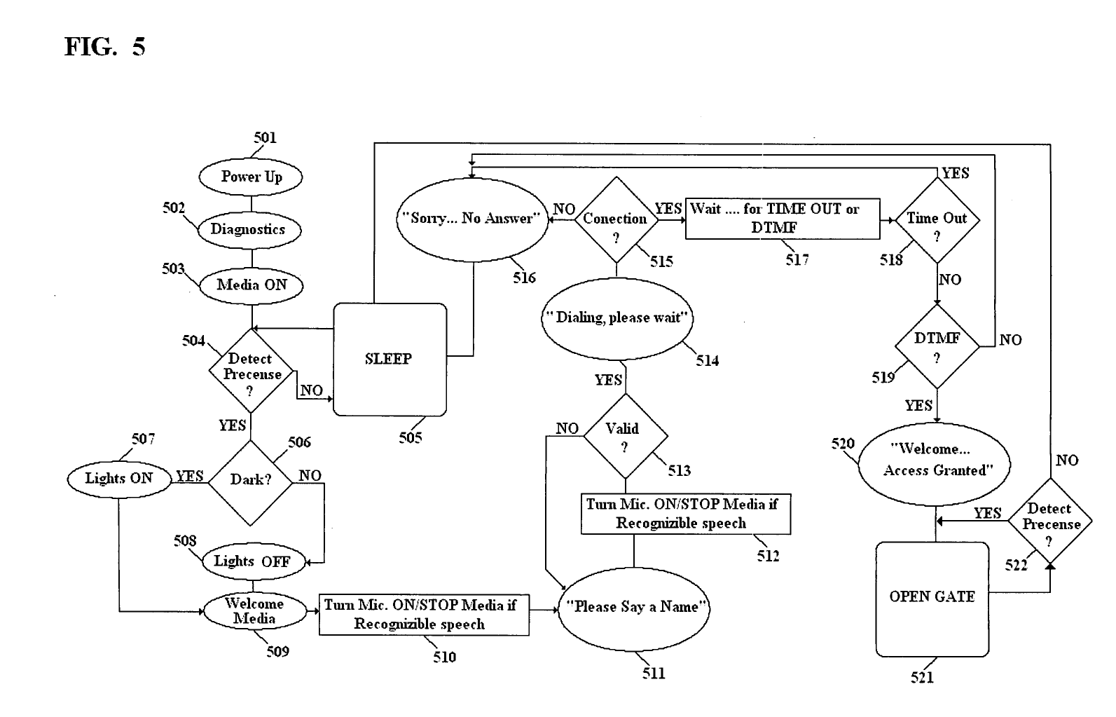

For example, a vehicle may pass over sensor 210 on driveway 112. The metal underneath the vehicle will create a signal relayed to circuitry 200 which in turn will initiate lighting, if appropriate, and the user interface or media displayed on display 201. Sensor 210 may then be a catalyst for switching access device from a power saving mode, for example a sleep mode, to an interactive mode ready to be utilized by some user (see FIG. 5).

Now turning to FIG. 3, a block diagram of internal components of an access device that utilizes hardware and software to receive, recognize, and process verbalized commands, in accordance to one embodiment of the present invention, is illustrated and discussed.

The internal components shown comprise of software 300, speaker 301, wireless interface 302, microphone 303, amplifier 304, echo canceller 308, voice enhancer 309, analog/digital (converter) 307, and relay 305.

Typically, a user may speak into speaker 303 sending mill volts, which are later converted to volts when they pass amplifier 304 to reach echo canceller 308 and X voice enhancer 309. Echo canceller 308 and voice enhancer 309 help produce better quality signal before reaching converter 307. Converter 307 takes the analog signal from the microphone and converts the data into digital data for software 300 to recognize and process. Finally, software 300 comprises of one or more programs designed to recognize speech, using one or more methods discussed above or known in the art.

As way of illustration, a user may speak a name into microphone 303. His voice will pass through amplifier 304, echo canceller 308, voice enhancer 309 and be converted into digital data at converter 307. Once software 300 recognizes the name provided by the user, software 300 derives an identification data which can be use to match that data with names in access device's database that are associated with the identification data—upon finding a match, wireless telephone 302 is used to establish a communication between the user and a party associated with the name provided by the user. Communication from the party associated with the provided name is facilitated via speaker 301 and at the party's request, a signal, for example a DTMF, may be sent via wireless telephone 302 to software 300. Software 300 relays the DTMF signal to relay 305 which in turn sends signal 306 to a device such as gate operator 110.

Turning to FIG. 4, reference is made to the illustration of a block diagram of the internal components of an access device that utilizes only software to receive, recognize, and process verbalized commands, in accordance to another embodiment of the present invention.

FIG. 4 shows an alternative design to the interior components of a device in accordance with another embodiment of the present invention. Here, a software also is utilized and replaces various hardware components such as voice enhancer 309, echo canceller 308, and analog/digital converter 307.

Like the embodiment discussed in reference to FIG. 3, the embodiment of a device disclosed in reference to FIG. 4 also comprises of common components such as speaker 401, wireless interface 402, microphone 403, amplifier 404, and relay 405 capable of transmitting signal 406. The main distinction here is software 400.

Typically, software 400 is more than one program, the various programs capable of converting analog signals into digital signals, enhancing voice quality, echo cancelling for clarity of speech received, speech synthesizing, and producing pre recorded speech to communicate with users, via speaker 401.

An embodiment of an access device such as the one illustrated by FIG. 4 may be desirable since no additional circuitry such as echo canceller 308 and voice enhancer 309 are necessary.

This may result in more lightweight equipment, and easier maintenance since only software 400 will have to be diagnosed and serviced rather than servicing hardware. Additionally, replacing software 400 may be much more convenient than replacing hardware on an access device.

Turning to the last figure of the drawings, FIG. 5 illustrates a flow chart of a method for speech recognition facilitated communication to monitor and control access to premises, in accordance with an exemplary embodiment of the present invention. The method is explained in the order shown below; however the following steps may be taken in any other conceivable sequence without deviating from the scope of the present invention.

In step 501, the communication device is turned on. This may be automatic upon supplying power to the device or may require using a switch. In step 502, the device performs a routine diagnostics test to determine whether its components are functioning properly. Typically, this step is performed automatically similar to a personal computer running its various programs when it is first turned on.

In step 503, media is initiated and the device is ready to commence receiving requests from users to establish communication with interested parties, for example tenants in a building.

In step 504 the access device waits for a detection signal from a sensor such as sensor 210. If for example, sensor 210 is not activated, in step 505, the access device goes into a sleep mode to conserve energy. Once a sensor is activated, for example sensor 210 detects a car driving up to the access device, the access device comes off the sleep mode and into an operational mode ready to receive input from a user.

In step 506, the access device makes a determination of the lighting conditions that affect the usability of the access device by users, such as whether it is dark outside or not—if it is night time, for example, the access device goes on to step 507 and turns on the lights. If there is no need to turn on lights around the access device, then the access device skips step 507 and in step 508 either keeps the lights off, or turns the lights off since lighting is no longer necessary.

In step 509, a welcome media may be activated to introduce them with instruction or welcome users, for example, give users instructions on what to say, how to input commands, or simply provide a welcome screen.

In step 510, a microphone may be activated to wait for a verbal communication or user input, for example stating the name of a tenant the user wishes to communicate with or for a tenant to let a user inside a premise. If no verbal communication or user input is immediately received, in step 511 the media will initiate a request for a response from a user to prompt the user for a command. For example, and without limiting the scope of the present invention, the access device may have automated pre-recorded or text generated speech that the user may hear and read on a display, such as “please say a name” prompting the user to provide a verbal communication, for example say the name of a person to which the access device may establish a communication with.

In step 512, between the prompt in step 511 and a validation determined in step 513, the microphone is turned on or kept on to receive user input or verbal communication. Although typically user input will be speech, for cases involving users unable to speak, for example disabled individuals, a user interface will include an input interface, for example a keypad such as key pad 202 for inputting the name of a tenant the user wishes to communicate with.

Once the access device receives a verbal communication or input from a user, in step 513 the circuitry or software being utilized by the access device derives an identification data. This identification data is in turn matched with data stored in the device's database. When the identification data is associated with a second user, for example a tenant within the premise, the device may be set up to immediately contact that tenant. If the identification data cannot be matched, then the access device may prompt the user to state another verbal communication, for example stating another name.

If the verbal communication is for example a password stated by the user, software or hardware in the access device then makes a determination of whether the stated password, which is then derived into an identification data, matches a password entry previously stored in the access device's database. Upon recognizing a password, the access device may be set up to relay a signal to grant the user access to the premise.

If the identification data cannot be matched, then the access device may prompt the user to state another verbal communication, for example stating another password or name.

Typically, the recognition and validation process in step 513, including deriving an identification data and matching that data with stored data, are achieved utilizing speech recognition technology implemented within the access device (see FIGS. 2, 3 and 4).

If the access device does not find a match, either because the user was not understood or because the input provided by the user, for example the name the user provided, did not match a name in the database, then the access device may repeat step 511 and prompt the user to provide a correct input.

For example, and without limiting the scope of the present invention, the access device may ask for another name, may response by informing the user that the provided name could not be found, or may provide a list of names that include names that closely represent the verbal communication or input provided by the user. Once a valid entry is determined, for example a user's verbal communication or input has been matched with a name or password in the database, the access device proceeds to establish a communication between the user and the tenant.

In step 514, as a connection is attempted by the access device, the access device may inform the user that a connection is being established. This interaction may be desirable to inform the user that his entry was valid and that no further input is necessary at this time.

In one embodiment, the access device displays a text on a screen informing the user that the access device is attempting to connect the user with the second party. In another embodiment, the access device may inform the user that an attempt is being made to establish a connection using an audible message. In yet another embodiment, both visual and audio mediums are used to inform a user that a connection is being established.

In step 515 a determination is made whether a connection is successful or not. If a connection was unsuccessful, for example the party being sought did not answer their telephone, then in step 516, the user is informed that the party sought by the user could not be reached. This may be achieved by providing an audio message or a text message, as discussed above, or any other way to inform the user that the connection was not successful.

In one embodiment, the access device may additionally prompt the user to choose from a number of options to reach the sought after party. For example, a user may be prompted to choose from several numbers the party has stored in the access device as alternative means of being reached when they are not within the premise. This may be a mobile phone number, a work phone number, or any other number where the party sought by the user may be reached at.

Upon the user leaving the proximity of the access device, if no further inputs are provide by a user, the access device may repeat step 505 again and go into a sleep mode.

If and when a connection is achieved, in step 517 the access device waits for a time out or a DTMF from the party at the other end of the line. A timeout may be desirable so that a user is provided limited communication time with the party granting access to the premise, giving other users a chance to use the access device, for example if the contacted party has an answering machine and the machine picks up a call from the access device, the answering machine might keep the line tied up.

In step 518, the access device determines whether a time out has occurred or not. Typically, a technician or an installer determines an appropriate time for a response or DTMF before setting off a timeout signal. If a timeout signal is set off in step 518, then the user is informed that either there was no answer or the time has ran out in step 516. If the user is unable to reach any party using the access device, then the access device returns to step 505 and goes into a sleep mode to preserve energy consumption.

If a timeout does not occur in step 518, then in step 519 the access device waits for a DTMF from the party communicating with the user. If the party desires to grant the user access to the premise, then that party provides the correct DTMF and in step 520 the user may be informed that access has been granted.

In step 521, the DTMF signal sent is relayed to a barrier operator, movable doorway, or gate operator for example, gate operator 110. The gate operator opens the gate, for example gate 109, and the user may access the premise.

Finally, once access is granted, the access device is ready to be utilized again. In step 522, if no presence is detected, for example the user has driven or passed through gate 110 and sensors do not detect a user's presence, then the gate, for example gate 110, closes and the access device turns to a sleep mode by repeating step 505.

A system and method for speech recognition assisted communication to monitor and control access to a premise has been described. The foregoing description of the various exemplary embodiments of the invention has been presented for the purposes of illustration and disclosure. It is not intended to be exhaustive or to limit the invention to the precise form disclosed. Many modifications and variations are possible in light of the above teaching. It is intended that the scope of the invention not be limited by this detailed description, but by the claims and the equivalents to the claims.

What is claimed is:

1. A method for operating a movable barrier to allow a first user access to a premises, comprising:
receiving a verbal communication from said first user;
utilizing a speech recognition circuitry to derive an identification data from said verbal communication;
matching said identification data with a second user;
contacting said second user associated with said identification data;
receiving a command from said second user to open said movable barrier;
relaying said command to a movable barrier operator connected to said movable barrier; and
granting said first user access to said premises.

2. The method of claim 1, wherein said verbal communication from said first user is in response to an automated audio instruction.

3. The method of claim 2, wherein said audio instruction is accompanied by a set of displaying text in a display monitor associated with said automated audio instruction.

4. The method of claim 2, further comprising:
granting access to said first user if said identification data derived from said verbal communication matches a predetermined access password to open said movable barrier.

5. The method of claim 4, wherein said automated audio instruction utilizes a programmed response requesting said predetermined access password.

6. The method of claim 5, wherein said command from said second user comprises a DTMF signal.

7. The method of claim 1, further comprising detecting a presence of said first user.

8. The method of claim 1, further comprising actuating a light source in response to sensing an environment lighting condition.

9. The method of claim 6, wherein contacting said second user is accomplished using a telephone network.

10. The method of claim 6, wherein contacting said second user is accomplished using a wireless network.

11. A system for controlling a movable barrier operator, comprising:
a circuitry for receiving a verbal communication from a first user;
a speech recognition circuitry for recognizing said verbal communication from said first user;
a controller for deriving an identification data from said verbal communication, wherein said identification data is associated with a second user;
a communication circuitry for communicating with said second user;
a network for establishing a communication between said first user and said second user;
a receiving circuitry for relaying a command from said second user; and
a relay for sending said command from said second user to said movable barrier operator.

12. The system of claim 11, wherein said controller searches a database to identify a contact information associated with said second user by matching said identification data with said contact information.

13. The system of claim 12, wherein said speech recognition circuitry for recognizing said verbal communication from said first user is configured for speaker-independent speech recognition.

14. The system of claim 12, wherein said speech recognition circuitry for recognizing said verbal communication from said first user is configured for speaker-dependent speech recognition.

15. The system of claim 11, wherein said receiving circuitry is configured for DTMF signaling.

16. The system of claim 15, wherein said command from said second user comprises a DTMF signal to open said movable barrier.

17. The system of claim 12, further comprising a user interface for communicating with said first user.

18. The system of claim 17, wherein said user interface prompts said first user with an automated audio instruction.

19. The system of claim 18, wherein said user interface displays a text associated with said automated audio instruction.

20. The system of claim 19, wherein said user interface displays an alphanumerical information associated with said second user.

21. The system of claim 20, wherein said network for establishing said communication with said second user is a telephone network.

22. The system of claim 20, wherein said network for establishing said communication with said second user is a wireless network.

23. The system of claim 12, wherein said circuitry for receiving said verbal communication is configured to reduce unwanted noise.

24. The system of claim 12, wherein said circuitry for receiving said verbal communication is configured to filter said verbal command from ambient noises.

25. The system of claim 12, wherein said speech recognition circuitry for recognizing said verbal communication utilizes a HMMs-based speech recognition method.

26. The system of claim 12, wherein said speech recognition circuitry for recognizing said verbal communication utilizes a neural networks-based speech recognition method.

27. The system of claim 12, wherein said speech recognition circuitry for recognizing said verbal communication utilizes an automatic speech recognition-based method.

28. The system of claim 12, wherein said speech recognition circuitry for recognizing said verbal communication utilizes a pattern matching algorithm-based speech recognition method.

29. The system of claim 12, wherein said speech recognition circuitry for recognizing said verbal communication utilizes a frequency estimation-based speech recognition method.

30. The system of claim 12, wherein said speech recognition circuitry for recognizing said verbal communication utilizes a matrix representation-based speech recognition method.

31. The system of claim 17, further comprising a light sensor to actuate luminosity to illuminate said user interface.

32. The system of claim 31, further comprising a sensor to activate said user interface upon detection of said first user.

33. The system of claim 32, wherein said sensor is an inductive sensor.

34. The system of claim 32, wherein said sensor is an capacitance sensor.

35. The system of claim 32, wherein said sensor is an magnetic sensor.

36. The system of claim 32, wherein said sensor is an ultrasonic sensor.

37. The system of claim 32, wherein said sensor is a retro reflective sensor.

38. The system of claim 32, wherein said sensor is an optical reflective sensor.

39. A system for controlling a movable barrier operator, comprising:
a circuitry for receiving a verbal communication from a first user;
a speech recognition circuitry for recognizing said verbal communication from said first user, wherein said speech recognition circuitry is configured for speaker-independent speech recognition;
a controller for:
deriving an identification data from said verbal communication,
wherein said identification data is associated with a second user,
searching a database to identify a contact information associated with said second user, and
matching said identification data with said contact information;
a communication circuitry for communicating with said second user;
a network for establishing a communication between said first user and said second user;
